(19) United States
(12) Patent Application Publication
(10) Pub. No.: US 2014/0359046 A1
(43) Pub. Date: Dec. 4, 2014

(54) PRELOADING OF SHARED OBJECTS

(71) Applicant: Renzo Colle, Stutensee (DE)

(72) Inventor: Renzo Colle, Stutensee (DE)

(73) Assignee: SAP AG, Walldorf (DE)

(21) Appl. No.: 13/908,512

(22) Filed: Jun. 3, 2013

(51) Int. Cl. H04L 29/06

(52) U.S. Cl. CPC H04L 29/06
USPC 709/213

(57) ABSTRACT

The present disclosure describes methods comprising generating a shared object in a shared memory of an application server, wherein the shared memory is a non-persistent memory, providing an instance key of the shared object for storage in a persistent memory upon occurrence of a first trigger event, and upon occurrence of a second trigger event, re-building the shared object in the shared memory of the application server, the re-building comprising: obtaining the stored instance key of the shared object, using the instance key to identify data stored on a database server associated with the shared object, and building the shared object in the shared memory of the application server using the identified data and systems adapted to implement these methods.

### TECHNICAL FIELD

The present disclosure relates to methods and systems for database systems. In particular, the present disclosure relates to a preloading method of a shared object and systems configured to use a preloading method.

### BACKGROUND

Modern database applications have to cope with large amounts of data organized in a complex manner to provide different functionalities to an end user. On the other hand, it is desired to present the user with a fast and seamless access to this data. This is particularly challenging if the database software is updated and/or patched such that parts of the system or the complete system have to be re-started.

### SUMMARY

In a first general aspect of the present disclosure, a method comprises generating a shared object in a shared memory of an application server, wherein the shared memory is a non-persistent memory, providing an instance key of the shared object for storage in a persistent memory upon occurrence of a first trigger event, and upon occurrence of a second trigger event, re-building the shared object in the shared memory of the application server, the re-building comprising: obtaining the stored instance key of the shared object, using the instance key to identify data stored on a database server associated with the shared object, and building the shared object in the shared memory of the application server using the identified data.

In a second aspect according to the first aspect, the first and the second trigger events are one single trigger event.

In a third aspect according to the first or second aspect, the first and/or second trigger events are a shutdown of the application server.

In a fourth aspect according to the first to third aspects, the first and/or second trigger events are a lapsing of a timer.

In a fifth aspect according to the fourth aspect, the timer is set to lapse periodically.

In a sixth aspect according to the first to fifth aspects, the first and/or second trigger events are not a user access to the shared object.

In a seventh aspect according to the first aspect, the first and/or second trigger events are determination that the shared object has become stale.

In an eighth aspect according to the seventh aspect determining that a shared object has become stale includes determining that metadata associated with the shared object, configuration data associated with the shared object, application data associated with the shared object, a transformation logic from design-time to runtime data associated with the shared object or a structure of the shared object has changed. Optionally, determining that metadata associated with the shared object, configuration data associated with the shared object, application data associated with the shared object, a transformation logic from design-time to runtime data associated with the shared object or a structure of the shared object has changed can include evaluating one or more of a timestamp of the shared object, a hash keys generated from content of the shared object, or a key of underlying metadata.

In a ninth aspect according to the first or second aspect, the first and/or second trigger events are a determination that a software update has been carried out on the database server.

In a tenth aspect according to anyone of the first to ninth aspects, the method further comprises generating one or more other shared objects in the shared memory of the application server; providing one instance key for each other shared object for storage in the persistent memory upon occurrence of the first trigger event; and upon occurrence of the second trigger event, re-building the other shared objects in the shared memory, the re-building comprising for each other shared object: obtaining the stored instance key of the respective other shared object; using the instance key to identify data stored on the database server associated with the respective other shared object; and building the respective other shared object in the shared memory of the application server using the identified data.

In an eleventh aspect according to anyone of the first to tenth aspects, the method further comprises generating a second shared object in a second shared memory of a second application server, wherein the second shared memory is a non-persistent memory; providing a second instance key of the shared object for storage in a persistent memory upon occurrence of a first trigger event; and upon occurrence of a second trigger event, re-building the shared object in the shared memory of the application server, the re-building comprising: obtaining the stored instance key of the shared object; using the instance key to identify data stored on a database server associated with the shared object; and building the shared object in the shared memory of the application server using the identified data.

In a twelfth aspect according to anyone of the first to eleventh aspects, the shared object is one of the list consisting of a business object, a user interface object, a report object, an object mapping the organizational structure of a company, an object including process agent metadata for integration, a fast search view object, a query object, or an object including status and action models. In particular, a shared object can include metadata, for instance metadata for tenant-specific partner or customer enhancements of the database system.

In a thirteenth aspect according to anyone of the first to twelfth aspects, the instance key includes information specific to the application server.

In a fourteenth aspect according to anyone of the first to thirteenth aspects, the application server is configured to provide services to two or more tenants simultaneously.

In a fifteenth aspect according to anyone of the first to fourteenth aspects, the instance key includes information specific to a particular tenant.

In a sixteenth general aspect of the present disclosure, a method comprises receiving at a database server an instance key of the shared object stored in a shared memory of an application server for storage in a persistent memory of the database server upon occurrence of a first trigger event, and upon occurrence of a second trigger event, re-building the shared object in the shared memory of the application server, the re-building comprising: providing the stored instance key of the shared object to the application server, providing data stored on the database server to build the shared object.

In a seventeenth general aspect of the present disclosure, a system comprises an application server including a shared memory configured to store shared objects, the application server configured to: provide an instance key of the shared object for storage in a persistent memory upon occurrence of a first trigger event; and upon occurrence of a second trigger event, re-build the shared object in the shared memory of the application server, the re-building comprising: obtain the stored instance key of the shared object; use the instance key to identify data stored on a database server associated with the shared object; and build the shared object in the shared memory of the application server using the identified data.

In a seventeenth general aspect of the present disclosure, a system comprises a database server including a persistent memory, the database server configured to: receiving an instance key of the shared object stored in a shared memory of an application server for storage in a persistent memory of the database server upon occurrence of a first trigger event; and upon occurrence of a second trigger event, re-building the shared object in the shared memory of the application server, the re-building comprising: providing the stored instance key of the shared object to the application server; providing data stored on the database server to build the shared object.

In an eighteenth aspect of the present disclosure, a computer readable medium includes instructions stored thereon, which, when executed on a processor or computing device, cause the processor or computing device to carry out the operations of any of the methods of the first to fifteenth aspects.

### BRIEF DESCRIPTION OF THE DRAWINGS

FIG. 1 illustrates an example database system of the present disclosure.

FIG. 2 illustrates an example database system of the present disclosure and details the structure of an example application server.

FIG. 3 illustrates example method for transforming design time metadata into runtime metadata in a suitable database system.

FIG. 4 illustrates example methods for storing and preloading shared objects in a suitable database system.

Reference numbers and designations in the various drawings indicate exemplary aspects, implementations or embodiments of particular features of the present disclosure.

### DETAILED DESCRIPTION

This disclosure generally to methods and systems for database systems. In particular, this disclosure relates to a preloading method for shared object and systems configured to use a preloading method.

The subject-matter described in this disclosure can be implemented in particular embodiments so as to realize one or more of the following advantages.

First, a delay to rebuild a shared object of an application server of a database system can be decreased. This can significantly reduce delays experienced by a user while using the database system and therefore enhance user experience (e.g., by several seconds to several minutes).

Second, a shared object in the shared memory can be rebuilt from design time metadata to a state before the rebuilt, while taking into account modifications in the design time metadata (e.g., due to a software update or patch). This can (further) decrease load time and provide for a seamless experience for a user using a database system as it can be avoided that a shared object is rebuilt to a wrong state.

As used in the present disclosure, the term “application server” refers to a server in a computer network on which applications are executed. In particular, an application server can provide for accessing a database (e.g., host processes of a system to retrieve, analyze and manipulate data stored in a database). A device hosting an application server is referred to as an application server device. An application server can be hosted on a dedicated device or on a multi-purpose device together with other programs. Details of example hardware for hosting application servers are discussed below.

An application server can have a shared memory. The shared memory is a memory area of the application server that can be accessed by multiple processes of the application server. For example, two processes can be set up to produce a first and a second ordered list of data stored in a data base, respectively. The content of the shared memory can be accessed by both processes. The shared memory is non-persistent, as it is arranged to provide for a fast access to its content as its content does not have to be read from persistent memory of a database server.

As used in the present disclosure, the term “object” has its usual meaning in the field of object-oriented programming. For example, a particular object is a runtime instance of a particular class. An object can contain data and be programmed to perform predetermined operations. The data contained in the object form the attributes of the object, the predetermined operations are the methods of the object.

For example, an object can map a real-world object. This can include a structure of the real world object and data associated with the real world object. The object encapsulates this structure and data and provides for an interface for a user to access the data of the object. For example, an object can map a sales order or an employee. Therefore, multiple objects of a particular class (e.g., “sales order” or “employee”) can exist simultaneously. In other examples, an object can also be used to map the organizational structure of a company. In this example, usually only a single object of this type exists per tenant.

Other examples of objects include user interface objects which provide a user with an environment to work with a database system or an analytical report object. Again, there can be multiple user interface objects at the same time. Still other examples of objects include search view objects, query objects, status objects and action model objects. An object can include enhancement metadata, for instance for tenant-specific customer-specific enhancements. In one illustrative example, an object can be a list of patients of an ambulance that is repeatedly read for reporting purposes.

As used in the present disclosure, a shared object is an object located in shared memory (e.g., of an application server). A shared object can be accessed by multiple users/in multiple sessions.

Each (shared) object has an instance key. The instance key is an identifier of the shared object (e.g., a name of the shared object or another alphanumerical string). In cases where only one instance of a particular object exists (overall or per tenant for tenant-specific shared objects) a default instance key can be used. For example, an object mapping the organizational structure of a particular tenant can have a default instance key as there usually is one such object per tenant. In other examples, a unique instance key can be generated for every object that is instantiated. In addition to the instance key, the (shared) object includes data content (for instance, metadata content).

As used in the present disclosure, the term “database server” refers to a server that includes a database and provides an interface to retrieve data from the database. A database server can be hosted on a dedicated database server device or on a multi-purpose device together with other programs. The database server includes repositories where data is stored. Details of example hardware for hosting database servers are discussed below.

Application servers and database servers can be integrated in a database system to provide database services to a user. For example, a user can launch processes to retrieve, analyze or manipulate data in the database. A database system can be embodied in any form of computer or computer network. For instance, a database system can be a web-based database system. Details of example hardware and networks for implementing database systems are discussed below.

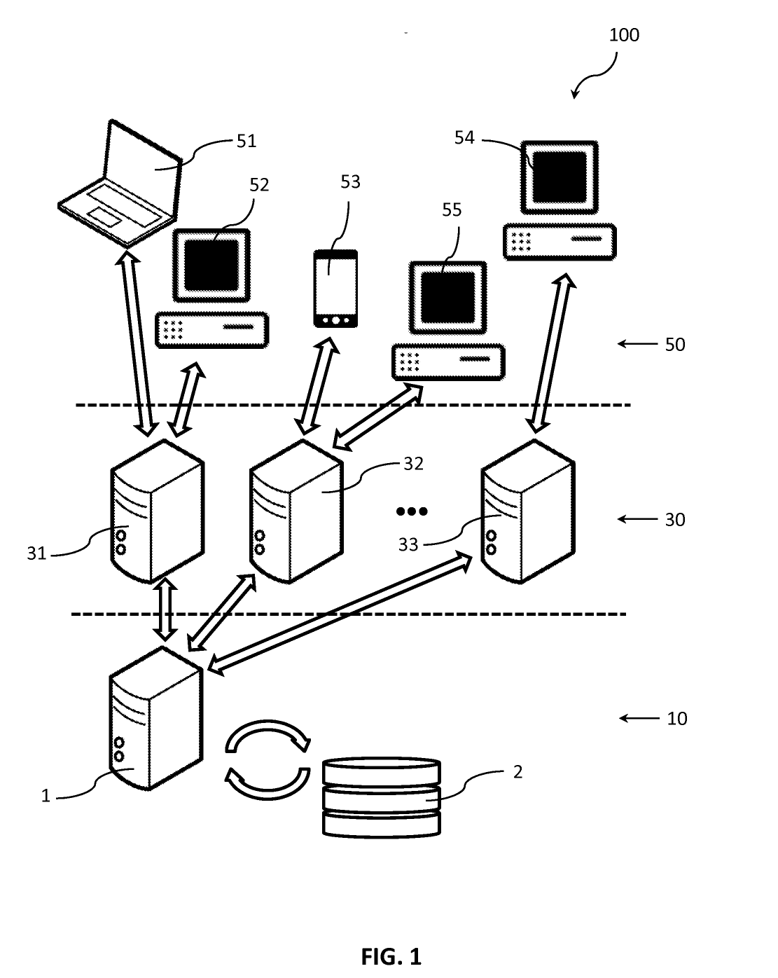

FIG. 1 is a schematic drawing of a database system 100 to provide database services to users. The dashed lines separate different software layers of the system 100. Even though different components of the system 100 are symbolized using symbols for physical devices in FIG. 1, FIG. 1 depicts a view of the functional components of the database system. Therefore, the components and the different layers can be embodied in many different hardware configurations. For instance, all layers can be hosted on a single host device. Alternatively, each layer can be hosted on at least one dedicated host, or any mixture of the two (or more). The application layer and the presentation layer can be distributed across any number of hosts.

Firstly, the system 100 has a database layer 10 including one database server, which includes a database management system 1 and the database 2. The database 2 is a persistent repository containing the data (e.g., patient data of an ambulance, sales data) administrated by the database system. The database layer can include a database buffer memory (not shown in FIG. 1) for storing data for faster access be the application servers 31, 32, 33. The database 2 can hosted on a single device or it can be distributed over multiple devices (which can also be located at different locations). Usually, the database 2 does not only include the data administrated by the database system, but also, e.g., code for applications related to the database system. A database system 100 can include multiple database servers.

The database layer 10 is connected to an application layer 30. The application layer 30 includes one or more application servers 31, 32, 33.

A presentation layer 50 contains the components that provide for user interfaces of the database system. For instance, the presentation layer 50 can contain graphical user interface (GUI) components 51, 52, 53, 54, 55. The presentation layer components can be hosted on any end user device. For instance, the presentation layer can be hosted on desktop computers of users, on workstations, or on mobile devices.

In the same manner, the different components of the database system 100 can communicate via any available computer network. For example, the database system 100 can be web-based so that the components communicate via the internet. In other examples, the components of the database system 100 can communicate over a company network. In other examples, the different components of the database system 100 are implemented on a single device (e.g. computer).

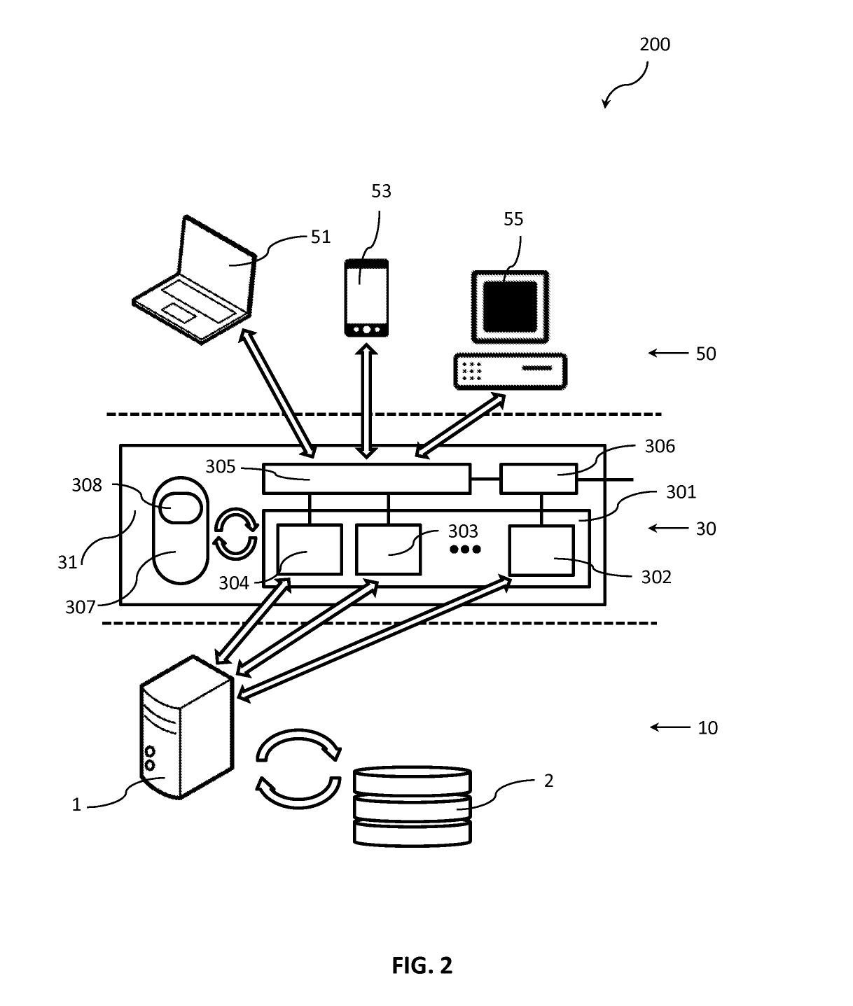

FIG. 2 illustrates a database system 200 having one application server 31. For instance, the application server 31 can be one of the application servers 31, 32, 33 of the database system 100 of FIG. 1. Components having the same reference numerals as in FIG. 1 refer to the same components.

The structure of an example application server 31 is explained in connection with FIG. 2. The application server 31 includes a shared memory 307. In the state depicted in FIG. 2, the shared memory 31 includes a shared object 308. Different processes 302, 303, 304 of the database system 100 run on the application server 31.

All processes 302, 303, 304 running on the application server 31 use resources (e.g., programs or table content). These resources can be stored in the shared memory 308. Thus, the shared memory 308 can be used to save or buffer resources (e.g., programs or table content in a table buffer) locally. Local buffering in the shared memory 308 can reduce a number of database reads what can make the database system faster. Usually, the shared memory 308 is much smaller than the persistent memory of the database 2.

Moreover, the application server 31 has a gateway 306 to communicate with other applications servers (e.g., application servers 32 and 33 shown in FIG. 1). In addition, the application server can have a dispatcher 305 linking the processes 302, 303, 304 with users. The users can access the systems via GUI components 51, 52, 53 hosted on user devices. As depicted in FIG. 2, the user devices can include desktop computers, laptop computers, but also PDAs or mobile phones.

It is desired to provide users with a fast access to data stored in database 2. One possibility to achieve this is to load the data into the shared memory of an application server. This, as explained above, can greatly accelerate access to this data. In order to be retrieved swiftly from the shared memory, the data can be transformed in a runtime-optimized format.

However, the shared memory's capacity is usually very small compared to the size of the database. In addition, not all data contained in the database has to be provided during runtime. For instance, the data stored in the database contains administrative data, documentation and governance information. This type of data can be interesting for the provider or programmers of the database system, but can have less or no relevance for the database service user. The data stored in the database including this data is called design time metadata and there is usually no need to provide all of it for presentation to the end user during runtime.

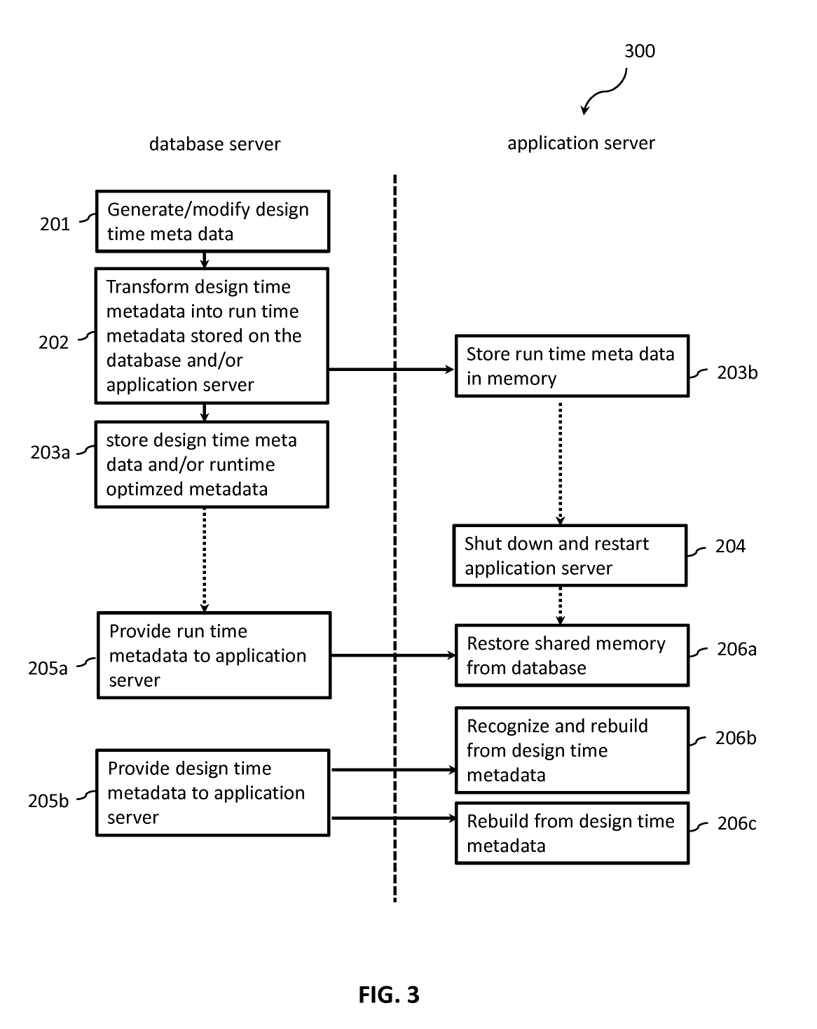

In order to speed up the system, the design time metadata is transformed to runtime-optimized metadata based on the probability that a piece of data is needed during runtime and the overall relevance of the piece of data. The runtime-optimized metadata is then provided for easy and fast access by a user. FIG. 3 includes a swim-lane diagram illustrating approaches to manage this transformation from design time metadata to runtime-optimized metadata. The left column of FIG. 3 shows operations carried out on a database server, the right column shows operations carried out on an application server. For instance, the process of FIG. 3 can be executed on the systems of FIG. 1 or 2.

The process 300 starts with a generation or modification of the design time metadata on the database server at 201. For example, the database system software can be updated, which can include changes in data that is runtime-relevant and data that is not runtime-relevant. After the generation or modification of the design time metadata (e.g., software update), the generated/modified design time metadata is stored in a persistent memory of the database at 203a.

The generated/modified design time metadata is then transformed into runtime-optimized metadata at 202. This runtime-optimized metadata can be provided to a shared memory of an application server at 203b, or stored in a persistent memory of the database at 203a. In other examples, the runtime-optimized metadata can be provide to the shared memory of the application server and simultaneously be stored in the persistent memory of the database. If the runtime-optimized data is provided to a shared memory of an application server, this can include using a shared object.

If the application server is shut down and restarted (e.g., after a software update) at 204, the content of its shared memory has to be rebuilt, as the shared memory is non-persistent so that its content is lost after shutdown. This usually is triggered by a user accessing a particular shared object. The process of FIG. 3 illustrates two different options to rebuild the content of the shared memory of the application server.

If the runtime-optimized object has been stored in the database, it has to be retrieved from the database and moved into the shared memory at 206a. If it has only to be provided to the shared memory, it has to be rebuilt from design time metadata. In the first case, when the runtime-optimized object has been stored in the database (e.g., in a table buffer of the database layer), the object's state can be inconsistent with the state for a particular user before the shutdown. For example, user defined changes might be lost. In this manner, the user can be negatively affected by the software update.

If the runtime-optimized data is stored in a shared object in the shared memory of the application server, the shared object has to be rebuilt at 206c (and possibly even recognized, if the runtime-optimized data is stored only in shared memory at 206b) from the design time metadata. However, due to the complexity of the runtime-optimized objects this can be a time consuming task. In real-world system, this rebuilding can take from several seconds to several minutes. During this time span, the user experience of the database system can be impaired, or, in extreme cases, the database system can even deliver no service to the user.

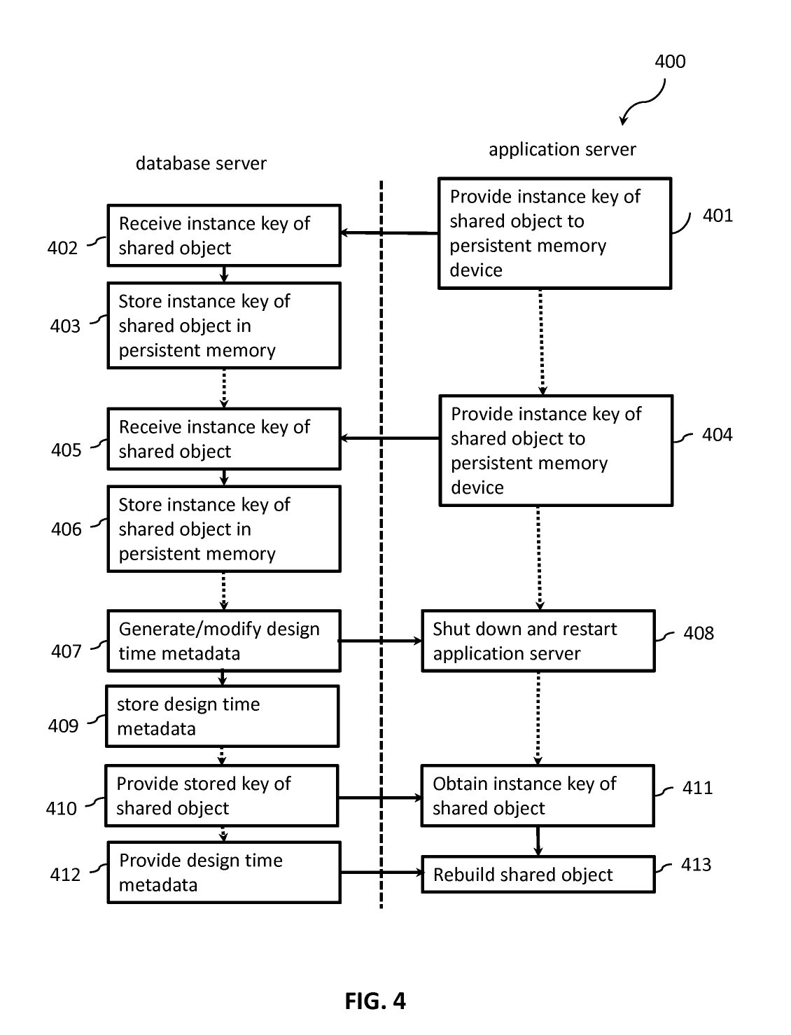

The systems and methods of the present disclosure can provide for a faster and more seamless database system. An exemplary process 400 is illustrated in connection with FIG. 4. In some instances, process 400 can be used instead of a process similar to that as described in FIG. 3.

At a certain point in time (not shown in FIG. 4), the application server instantiates a particular shared object in its shared memory. For a certain amount of time, the object persists in the shared memory of the application server. Upon occurrence of a first trigger event (not show in FIG. 4), the application server provides an instance key of the shared object for storing in a persistent memory at 401. For instance, a database server (e.g., the database server of FIG. 1 or 2) can receive the instance key of the shared object and store it at 402. The database server stores the instance key so that, if the shared memory of the application server is emptied (e.g., due to a shutdown of the application server), the instance key is still retrievable. For instance, the database server can store the instance key in a persistent memory area.

While in the example of FIG. 4 the instance key is stored by the database server, another entity can also take over the task of storing the instance key. The only requirement is that the instance key is stored in a way that it is not lost if the non-persistent shared memory of the application server is emptied (e.g., upon shut-down of the application server).

The generation of the first trigger event can be executed by the application server, by the database server or by another entity. The first trigger event can be the lapsing of a timer. The timer can be set by a programmer or user to a predetermined time span after which storing the instance key of the shared object is desired. In some examples, the first trigger event is generated periodically (e.g., every 15 minutes), where the period of the generation of the first trigger event can be variable (e.g., varying with the access frequency of the shared object by the user).

In other examples, the first trigger event can be a state change of the application server or the database server. For instance, the application server or the database server can detect that a shutdown of the application server is imminent. In other examples, the database server or the application server can detect that a software update on the database server has been carried out. In other examples, a user modification of the database system can be detected by the database system (e.g., a user can add a field to a table).

In still other examples, the first trigger event can be that the shared object has become stale. The shared object is stale if a modification of the database system configuration would result in changes in the object. This can include one or more of the following aspects. In one aspect, data associated with the shared object can be modified. In another aspect, the structure of the shared object's class can be modified (e.g., a modification of the sales process which is mapped to a shared object). In still another aspect, a transformation logic that transforms design-time data into runtime-optimized data can be changed (what can result in different runtime-optimized data for the same design-time data). These changes can be the result of, e.g., updates and patches where dedicated objects are imported, changes by customers with regard to enhancements or for the application side changed by customers to master-data or configuration. In these situations, the shared object is no longer an up-to-date instance of the particular class.

The application server or the database server can monitor the above described modifications or changes and can detect that the shared object is stale. For example, the application server or the database server can evaluate a time stamp or other indicator of a generation or modification time of the shared object and determine that the object has become stale if the generation or modification time is more remote than a predetermined threshold from a current time or occurs before a particular event (e.g., a data modification, a modification of the shared object's class or a modification of the transformation logic for the shared object). In other examples, the application server or the database server can evaluate hash keys generated from content of the shared object, or a key of underlying metadata. In other examples, the first trigger event is not a user accessing the shared object in the shared memory of the application server.

The different first trigger events described above can also be used in combination. For instance, a database system can be configured to trigger storing of a shared object's instance key periodically and immediately before a shutdown of the application server takes place. In other examples, the database system can store the instance key of the shared object periodically and before a software update is carried out.

In the example of FIG. 4, the instance key is stored periodically. After the database server has received and stored the instance key for a first time at 402, 403 and a predetermined time has lapsed, the application server provides for storage an updated instance key of the shared object at 404 (the updated instance key can contain the same set of data as the previously provided instance key or modified data). Again, the database server receives the instance key from the application server at 405 and stores it at 406 in its persistent memory.

A predetermined amount of time after this operation, design time metadata of the database server is generated or modified at 407. For example, the database system software can be updated or patched. In another example, a user can modify the database. As modern database system have a high level of complexity and offer a vast number of different services, software updates and patches or user modifications can occur frequently. Design time metadata refers to any data related to the database system software (e.g., source code, but also administrative data, documentation or governance information) except for data content of the database.

After the design time metadata is modified or generated on the database server, it is stored in the persistent memory of the database server at 409. The design time metadata can have a considerable complexity. It can include structures spanning multiple database tables and even multiple meta-objects.

In the process shown in FIG. 4, the design time metadata is not necessarily directly transformed to runtime metadata (e.g., by generating a shared object in the shared memory of the application server). However, the transformation techniques shown in FIG. 3 can also be employed in the process of FIG. 4.

At some point in time, the application server is shut down and restarted at 408. For example, the shutdown in restart can be triggered by a determination (of the database server or the application server) that a software update has taken place and a new software package or software version relevant for the processes running on the application server is available. The shutdown results in a loss of the content of the non-persistent shared memory. In order to provide the user of the database system with a seamless user experience (e.g., by minimizing delays and avoiding inconsistencies between the state of the system before and after the shutdown of the application server), the shared object previously included in the shared memory of the application server is restored.

In contrast to the processes described in connection with FIG. 3, the rebuilt process of the shared object starts with the database server providing the instance key of the shared object to the application server at 410. The application server obtains the instance key of the shared object at 411. The application server can use the instance key to identify data stored on the database server required to rebuild the shared object in its shared memory at 413. For example, by rebuilding the shared object using the instance key, the application server can directly request the newly generated or modified design time metadata relevant for the particular shared object from the database server. In the example process of FIG. 4, the database server provides the application server with the relevant design time metadata at 412. After having received this data, the application server can rebuild the shared object in the shared memory of the application server. In other examples, the rebuilding of the shared object can be carried out by the database server. In this situation, the database server rebuilds the shared object using the stored instance key obtained from the application server. After having rebuilt the shared object, the database server shifts it to the shared memory of the application server.

As the shared object is rebuilt by the application server (or the database server, or both), the rebuilt shared object on the one hand reproduces the state of the shared object prior to the shutdown of the application server. This can be advantageous as the shared object can contain application server-specific or user-specific modifications, that can be lost if a developer version of the shared object is used as a “blueprint” for rebuilding the shared object (what can substantially impair the seamless user experience). On the other hand, the application server rebuilds the shared object by using the instance key and therefore accesses the relevant newly generated or modified design time metadata. As a consequence, the rebuilt shared object is “up to date,” as the latest modifications and changes, e.g., due to software updates, are taken into account.

If, as illustrated in connection with FIG. 3, the runtime-optimized data is stored on the database server after, e.g., a software update and is retrieved after the application server has restarted, the shared object can be in a wrong state.

The rebuild process is triggered by a second trigger event. In general, second trigger events for triggering rebuilding of the shared object in the shared memory of the application server can include the same types as the first trigger events triggering storing of the instance key of the shared object described above. For example, as illustrated in the example of FIG. 4, the rebuilt process can be triggered by a restart of the application server. In other examples, the second trigger even can be that data associated with the shared object has been modified, that the structure of the shared object's class has been modified or that a transformation logic that transforms design-time data into runtime-optimized data has been modified. For example, the second trigger event can be a software update, a patching of a software package of the database system software, or a user modification of the database system. In other examples, the second trigger event is the lapse of a timer. In other examples, the first trigger event is not a user accessing the shared object in the shared memory of the application server.

In some examples, the first and second trigger events are coincident or the same event can be used as first and second trigger event. For example, a trigger event could be the installation of a new software version, the patching of a software package on the database server or a user modification of the database system. This event could trigger i) that the application server provides for storage an instance key of the shared object and ii) that the shared object is rebuilt in the shared memory of the application server (e.g., after the new software version has been installed on the database server). In other examples, the instance key of the shared object can be provided by the application server and stored by the database server periodically following by a rebuilt of the shared object in the shared memory of the application server.

If, as shown in the process of FIG. 3, the runtime data is stored on the database server and/or the application server as a shared object and the shared object is rebuilt upon a user accessing the shared object from the design time metadata. This can take a considerable amount of time (as described above, ranging from several second to minutes) during which the performance of the database system is impaired. In the process of FIG. 4 where the rebuilt process is triggered by a second trigger event, the rebuild process using the instance key of the shared object can already completed when a user accesses the shared object. This can result speed-up the database system considerably. Ideally, the user can operate the database system continuously without recognizing that a software update has taken place.

In a modification of the process of FIG. 4, the application server is not shut down. Nevertheless, the shared object is rebuilt upon occurrence of on the second trigger events described above. For example, the shared object can be rebuilt upon determination that the shared object has become stale (e.g., when a software patch or update or a user modification results in modifications of the shared object, as discussed above). In this manner, the shared objects can be rebuilt to their up-to-date versions continuously while the database system is running. Ideally, the user does not even recognize the continuous rebuilt process but nevertheless always operates with up-to-date shared objects.

In the context of FIG. 4 it has been described that the application server provides the instance key of a single shared object for storage on the database server. However, the methods and systems of FIGS. 1 to 4 are not limited to a situation where only one shared object is contained in the shared memory of an application server. In general, the shared memory of an application server can include multiple shared objects. The methods described in connection with FIG. 4 can be executed for some, or all, of the shared objects in the shared memory of the application server.

In some examples, the first and second trigger events are defined globally for all shared objects in the shared memory of an application server. For instance, the application server can provide the instance keys of all shared objects contained in its shared memory for storage to a database server periodically. In other examples, the instance keys of all shared objects currently contained in the shared memory can be provided by the application server if, e.g., a shutdown is imminent or a software update process takes place.

In other examples, first and second trigger events can be defined individually for different shared objects or types of shared objects in the shared memory of a particular application server. For example, the first trigger event can be the lapse of a predetermined time after a particular object has been generated in the shared memory of the application server. As a consequence, if the shared memory of the application server is populated with shared objects generated at different times, the application server provides for storage the instance keys of the respective objects at different times. In other examples, the first and second trigger events can be defined based on the type of the particular object. For instance, a first type of object can have a higher frequency of storing the respective shared object instance key than a second type of object. In other examples, the instance keys of a first type of objects can be stored periodically while the instance keys of a second type of objects can be stored if a shutdown of the application server is imminent.

As illustrated in FIG. 1, there is a single database server in the database system. However, a database system can contain multiple database servers in other implementations. In this situation, the instance keys of the shared objects of the application server can be provided to and stored by one particular or several of the database servers. In some examples, the database server on which a particular instance key of a shared object is stored is selected based on the location of the design time metadata required to rebuild the particular shared object. If, e.g., all or a majority of the design time metadata required to rebuild a particular shared object resides on a particular database server, the instance key of this shared object can be provided to this database server by the application server.

As illustrated in FIG. 1, a database system can have multiple application servers running concurrently (e.g., application servers 31, 32, 33). Each of these multiple application servers has its dedicated shared memory which can contain one or more shared objects. The methods described in connection with FIG. 4 above can be carried out by each of the multiple application servers. The first and second trigger events can be defined globally for all application servers associated with a particular database server. For example, the instance keys of all shared objects contained in the shared memories of the multiple application servers can be provided periodically by the respective application server at the same time. In other examples, the first sand second trigger events are defined separately for each application server. For instance, the second trigger event for rebuilding the shared objects in a shared memory of a particular application server can be a software update that affects processes running on this particular application server. Other application servers not affected by the particular software update can be left untouched.

It has been described above that the instance keys of the shared objects are provided by the application server or multiple application servers for storage on a database server. However, in some examples, the instance keys of the shared object of one application server are provided to and stored by a second application server. As can be seen in FIG. 2, different application servers 31 are networked by gateway 306. In this manner, e.g., if the shared memory of the first application server has been emptied after a shutdown and the first application server restarts, the first application server can obtain the instance key of its shared object from the second application server (e.g., via gateway 306).

The database systems described above can be configured to serve multiple clients (“tenants”) simultaneously. Different tenants can have an affinity to different application servers (as, e.g., all users of a particular application server can access the content of the shared memory of the particular application server). Multiple tenants can be associated with a single application server. Therefore, the processes described above can be tenant-specific. This means that for each tenant the instance keys of all its shared objects are provided by the particular application server and stored on the database server. As the shared objects can have tenant-specific modifications, the instance keys of shared objects providing similar functions for different tenants can differ significantly. In addition, the runtime metadata is often tenant-specific. Therefore, the application server can rebuild the runtime metadata from the design time metadata separately for every tenant. An example variation of the method of FIG. 4 for a multi-tenant system can include that a single application server can be associated with both a first and a second tenant, such that the first tenant periodically provides its first instance keys of the shared objects in the application server's shared memory to the database server for storage. In addition, the second tenant associated with the single application server can provide its second instance keys of shared objects stored in the application server's shared memory. The database server stores both the first and second instance keys and information regarding with which tenant they are associated. Later, the application server, when operating with the first tenant's instance, obtains the first instance keys and rebuilds the shared objects associated with the first tenant's instance. Likewise, the application server, when operating with the second tenant's instance, obtains the second instance keys and rebuilds the shared objects associated with the second tenant's instance.

As described above, the processes of FIG. 4 can be “application server aware,” i.e., rebuilding the shared objects of a particular application server can take into account (e.g., reproducing) a state of the shared objects of the particular application server before the rebuilt has been triggered (e.g., before a shutdown and restart of the application server). In addition, the process of FIG. 4 can be “tenant aware,” i.e., rebuilding the shared objects of a particular tenant can be rebuilt taking into account (e.g., reproducing) a state of the shared objects of the particular tenant before the rebuilt has been triggered (e.g., before a shutdown and restart of the application server).

In connection with FIGS. 1 and 2 a database system has been described in a description referring to logical components. As already stated above, the different components (e.g., application server, database server, user interfaces) can be embodied in different hardware environments.

At a high level, the application and the database server are associated with a computer or processor. A computer or processor comprises an electronic computing unit (e.g., a processor) operable to receive, transmit, process, store, or manage data and information associated with an operating environment of the database system. As used in the present disclosure, the term “computer” or “processor” is intended to encompass any suitable processing device. The term “processor” is to be understood as being a single processor that is configured to perform operations as defined by one or more aspects described in this disclosure, or the “processor” comprises two or more processors, that are configured to perform the same operations, e.g. in a manner that the operations are distributed among the two or more processors. The processor may comprise multiple organic field-effect transistors or thin film transistors or a combination thereof. This may allow processing the operations in parallel by the two or more processors. The two or more processors may be arranged within a supercomputer, the supercomputer may comprise multiple cores allowing for parallel processing of the operations. For instance, computer or processor may be a desktop or a laptop computer, a cellular phone, a smartphone, a personal digital assistant, a tablet computer, an e-book reader or a mobile player of media. Furthermore, the operating environment of the database system can be implemented using any number of servers, as well as computers other than servers, including a server pool. Indeed, the computer or processor and the server may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, the computer, processor and server may be adapted to execute any operating system, including Linux, UNIX, Windows, Mac OS, iOS, Android or any other suitable operating system.

The term “computing device”, “server” or “processor” encompasses all kinds of apparatus, devices, and machines for processing data, including by way of example a programmable processor, a computer, a system on a chip, or multiple ones, or combinations of the foregoing. The apparatus can include special purpose logic circuitry, e.g., an FPGA (field programmable gate array), a CUDA (Compute Unified Device Architecture) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and operating environment can realize various different computing model infrastructures. In enterprise systems, there are OLTP (OnLine Transaction processing) systems used to carry out business processes of a company where employees and other stakeholders, such as suppliers or customers, follow a business process which may result in business documents created in a database of the OLTP system. The database system can include in-memory databases in addition to the persistent databases described in connection with FIGS. 1 and 2 and thereby exploit recent innovations in hardware to run a database in main memory. In an implementation of the present disclosure described herein, the servers may be types of a Java development platform, such as e.g., Enterprise JavaBeans® (EJB), J2EE Connector Architecture (JCA), Java Messaging Service (JMS), Java Naming and Directory Interface (JNDI), and Java Database Connectivity (JDBC), a ByDesign platform, SuccessFactors Platform, ERP Suite technology or in-memory database such as High Performance Analytic Appliance (HANA) platform. In an aspect, the servers may be based on two different of the above mentioned platforms.

Regardless of the particular implementation, “software” or “operations” may include computer-readable instructions, firmware, wired or programmed hardware, or any combination thereof on a tangible and non-transitory medium operable when executed to perform at least the processes and operations described herein. Indeed, each software component may be fully or partially written or described in any appropriate computer language including C, C++, Java, Visual Basic, assembler, Python and R, Perl, any suitable version of 4GL, as well as others.

The figures and accompanying description illustrate example processes and computer-implementable techniques. However, the database system operating environment (or its software or hardware components) contemplates using, implementing, or executing any suitable technique for performing these and other processes. It will be understood that these processes are for illustration purposes only and that the described or similar techniques may be performed at any appropriate time, including concurrently, individually, or in combination. In addition, many of the operations in these processes may take place simultaneously, concurrently, and/or in different orders or combinations than shown. Moreover, operating environment may use processes with additional operations, fewer operations, and/or different operations, so long as the methods remain appropriate.

Aspects of the subject-matter and the operations described in this specification can be implemented in digital electronic circuitry, semiconductor circuits, analog circuits, or in computer software, firmware, or hardware, including the structures disclosed in this specification and their structural equivalents, or in combinations of one or more of them. Embodiments of the subject-matter described in this specification can be implemented as one or more computer programs, i.e., one or more modules of computer program instructions, encoded on computer storage medium for execution by, or to control the operation of a data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices). The operations described in this specification can be implemented as operations performed by a data processing apparatus on data stored on one or more computer-readable storage devices or received from other sources.

A computer program (also known as a program, software, software application, script, or code) or “user interface” can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The term “graphical user interface,” or GUI, may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of user interface (UI) “icons”, some or all associated with a web browser, such as interactive fields, pull-down lists, and buttons operable by the user of the computing device hosting the UI. These and other UI icons may be related to or represent the functions of the web browser. The term “browser user interface” refers to a graphical user interface embedded in a web browser environment on the remote computing device. The browser user interface may be configured to initiate a request for a uniform resource locator (URL) and may be configured to display a retrieved web page such as an HTML coded web page. The browser user interface may comprise displayed or hidden icons which, upon activation, initiate an associated electronic process inside or outside the remote computing device. For example, the browser user interface may be Internet Explorer, Chrome or Firefox. “Creating an icon” is to be understood as generating a new icon on the user interface. “Modifying an icon” is to be understood as changing a property of an existing icon on the user interface. “Deleting an icon” is to be understood as vanishing an existing icon on the user interface, e.g., for replacement by a newly created icon. “Updating the user interface” thereby is to be understood as creating, modifying, or deleting an icon on the user interface.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer or computer or processor may be a processor for performing actions in accordance with instructions and one or more memory devices for storing instructions and data. Generally, a computer or computer or processor will also include, or be operatively coupled to receive data from or transfer data to, or both, one or more mass storage devices for storing data, e.g., magnetic, magneto optical disks, or optical disks. However, a computer or computing device need not have such devices. Moreover, a computer or computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the user interface described in this specification can be implemented on a computer having a non-flexible or flexible screen, e.g., a CRT (cathode ray tube), LCD (liquid crystal display) or OLED (organic light emitting diode) monitor, for displaying information to the user and a keyboard and a pointer, e.g., a finger, a stylus, a mouse or a trackball, by which the user can provide input to the computer. Other kinds of devices can be used to provide for interaction with a user as well; for example, feedback provided to the user can be any form of sensory feedback, e.g., touch feedback, visual feedback, auditory feedback, or tactile feedback; and input from the user can be received in any form, including acoustic, speech, touch or tactile input. In addition, a computer or computer or processor can interact with a user by sending documents to and receiving documents from a device that is used by the user; for example, by sending web pages to a web browser on a user's user device in response to requests received from the web browser.

Implementations of the subject-matter described in this specification can be implemented in a computing system that includes a back end component, e.g., as a server, or that includes a middleware component, e.g., an application server, or that includes a front end component, e.g., a user computer having a graphical user interface or a Web browser through which a user can interact with an implementation of the subject-matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include users and servers. A user and server are generally remote from each other and typically interact through a communication network. The relationship of user and server arises by virtue of computer programs running on the respective computers and having a user-server relationship to each other. In some implementations, a server transmits data (e.g., an HTML page) to a user device (e.g., for purposes of displaying data to and receiving user input from a user interacting with the user device). Data generated at the user device (e.g., a result of the user interaction) can be received from the user device at the server.

While this specification contains many specific implementation details, these should not be construed as limitations on the scope of any implementation or on the scope of what may be claimed, but rather as descriptions of features that may be specific to particular implementations of particular implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations, alterations, and permutations of the described implementations are within the scope of the following claims as will be apparent to those skilled in the art. For example, the operations recited in the claims can be performed in a different order and still achieve desirable results.

Accordingly, the above description of example implementations does not define or constrain this disclosure. Other changes, substitutions, and alterations are also possible without departing from the spirit and scope of this disclosure.

What is claimed is:

1. A method, comprising:
generating a shared object in a shared memory of an application server, wherein the shared memory is a non-persistent memory;
providing an instance key of the shared object for storage in a persistent memory upon occurrence of a first trigger event; and upon occurrence of a second trigger event, re-building the shared object in the shared memory of the application server, the re-building comprising:
obtaining the stored instance key of the shared object;
using the instance key to identify data stored on a database server associated with the shared object; and
building the shared object in the shared memory of the application server using the identified data.

2. The method of claim 1, wherein the first and the second trigger events are one single trigger event.

3. The method of claim 1, wherein at least one of the first or second trigger events is a shutdown of the application server.

4. The method of claim 1, wherein at least one of the first or second trigger events is a lapsing of a timer.

5. The method of claim 4, wherein the timer is set to lapse periodically.

6. The method of claim 1, wherein the first and/or second trigger events are not a user access to the shared object.

7. The method of claim 1, wherein at least one of the first or second trigger events are a determination that the shared object has become stale.

8. The method of claim 7, wherein determining that a shared object has become stale includes determining that metadata associated with the shared object, configuration data associated with the shared object, application data associated with the shared object, a transformation logic from design-time to runtime data associated with the shared object or a structure of the shared object has changed.

9. The method of claim 8, wherein determining that metadata associated with the shared object, configuration data associated with the shared object, application data associated with the shared object, a transformation logic from design-time to runtime data associated with the shared object or a structure of the shared object has changed includes one or more of evaluating a timestamp of the shared object, a hash key generated from content of the shared object, or a key of underlying metadata.

10. The method of claim 1, wherein at least one of the first or second trigger events is a determination that a software update has been carried out on the database server.

11. The method of claim 1, further comprising:
generating one or more other shared objects in the shared memory of the application server;
providing one instance key for each other shared object for storage in the persistent memory upon occurrence of the first trigger event; and
upon occurrence of the second trigger event, re-building the other shared objects in the shared memory, the re-building comprising for each other shared object:
obtaining the stored instance key of the respective other shared object;
using the instance key to identify data stored on the database server associated with the respective other shared object; and
building the respective other shared object in the shared memory of the application server using the identified data.

12. The method of claim 1, further comprising:
generating a second shared object in a second shared memory of a second application server, wherein the second shared memory is a non-persistent memory;
providing a second instance key of the shared object for storage in a persistent memory upon occurrence of a first trigger event; and
upon occurrence of a second trigger event, re-building the shared object in the shared memory of the application server, the re-building comprising:
obtaining the stored instance key of the shared object;
using the instance key to identify data stored on a database server associated with the shared object; and
building the shared object in the shared memory of the application server using the identified data.

13. The method of claim 1, wherein the shared object is one of the list consisting of a business object, a user interface object, a report object, an object mapping the organizational structure of a company, an object including process agent metadata for integration, a fast search view object and query metadata object, an object including status and action models.

14. The method of claim 1, wherein the instance key includes information specific to the application server.

15. The method of claim 1, wherein the application server is configured to provide services to two or more tenants simultaneously.

16. The method of claim 1, wherein the instance key includes information specific to a particular tenant.

17. A method, comprising:
receiving at a database server an instance key of the shared object stored in a shared memory of an application server for storage in a persistent memory of the database server upon occurrence of a first trigger event; and
upon occurrence of a second trigger event, re-building the shared object in the shared memory of the application server, the re-building comprising:
providing the stored instance key of the shared object to the application server;
providing data stored on the database server to build the shared object.

18. A system, comprising:
an application server including a shared memory configured to store shared objects, the application server configured to:
provide an instance key of the shared object for storage in a persistent memory upon occurrence of a first trigger event; and
upon occurrence of a second trigger event, re-build the shared object in the shared memory of the application server, the re-building comprising:
obtain the stored instance key of the shared object;
use the instance key to identify data stored on a database server associated with the shared object; and
build the shared object in the shared memory of the application server using the identified data.

19. A system, comprising:
a database server including a persistent memory, the database server configured to:
receiving an instance key of the shared object stored in a shared memory of an application server for storage in a persistent memory of the database server upon occurrence of a first trigger event; and
upon occurrence of a second trigger event, re-building the shared object in the shared memory of the application server, the re-building comprising:
providing the stored instance key of the shared object to the application server;
providing data stored on the database server to build the shared object.

20. The system of claim 18, wherein the system includes one or more additional application servers.

21. The system of claim 18, wherein the system includes one or more graphical user interfaces to provide one or more users with access to the system.
